(19) United States
(12) Patent Application Publication
(10) Pub. No.: US 2013/0149439 A1
(43) Pub. Date: Jun. 13, 2013

(54) ELECTRODE FORMING METHOD RELATING TO HEAT GENERATING FIXING BELT, HEAT GENERATING FIXING BELT AND FIXING APPARATUS

(71) Applicants: Junji UJIHARA, Tokyo (JP); Eiichi YOSHIDA, Tokyo (JP)

(72) Inventors: Junji UJIHARA, Tokyo (JP); Eiichi YOSHIDA, Tokyo (JP)

(21) Appl. No.: 13/693,224

(22) Filed: Dec. 4, 2012

(30) Foreign Application Priority Data
Dec. 12, 2011 (JP) 2011-271130

(51) Int. Cl. B05D 5/12; G03G 15/20

(52) U.S. Cl. CPC G03G 15/2057; B82Y 30/00
USPC 427/123; 399/333; 427/125; 977/773

(57) ABSTRACT

The method of forming an electrode in a heat generating fixing belt entails supplying a colloid liquid where metal nano-particles are dispersed in a liquid medium, on the surface of an electrically resistant heat generating layer and forming a plated film by an electroless plating method using the metal nano-particles as a catalyst. The electrically resistant heat generating layer is composed of a resin. In this manner, a pair of electrodes are formed on the surface of the electrically resistant heat generating layer. The electrodes supply electric current to the electrically resistant heat generating layer. The heat generating fixing belt can maintain an initial conduction resistance for a long period of time.

### BACKGROUND OF THE INVENTION

1. Field of the Invention

The present invention relates to a method of forming an electrode relating to a heat generating fixing belt for heat-fixing a toner image formed according to an image forming method of an electrophotographic system on an image support, a heat generating fixing belt, and a fixing apparatus provided with the heat generating fixing belt.

2. Description of the Related Art

In an image forming apparatus such as a copier or a laser beam printer, there has been conventionally employed, as a method of fixing an unfixed toner image which has been transferred, after toner development, onto an image support such as plain paper or the like, a contact-heat-fixing system using a heat roller system.

With respect to the heat roller system, however, there are problems that it takes time to raise its temperature up to the fixable temperature and a lot of heat energy is required. Recently, a heat film fixing system has become a main stream from the viewpoint of shortening the time from activation of a power source to copy start (the so-called warming-up time) and energy saving.

In a fixing apparatus of this heat film fixing system, there is used a seamless fixing belt in which a releasing layer of a fluororesin or the like is superimposed on the outer surface of a heat-resistant film formed of polyimide and the like.

In the fixing apparatus of such a heat film fixing system, for example, since a heat-resistant film is heated through a ceramic heater and a toner image is fixed on the heat-resistant film surface, the heat conductivity of the heat-resistant film becomes an important point. However, thinning the heat-resistant film to enhance the thermal conductivity results in lowering of mechanical strength, rendering it difficult to be rotated, whereby applications to medium-speed to high-speed machines are difficult and a ceramic heater is easily broken, which is problematic.

To overcome such problems, recently, there have been proposed a fixing apparatus where an electrically resistant heat generating layer having a heat generating body is incorporated into a fixing belt itself, and by supplying an electric current to the electrically resistant heat generating layer, the fixing belt is directly heated to fix a toner image (for example, refer to Patent Literatures 1 to 4). An image forming apparatus provided with a fixing apparatus of this system, which features a shortened warming-up time and also less power consumption than the heat film fixing system, is superior in terms of energy saving and speeding-up.

In the fixing belt (heat generating fixing belt) provided with the electrically resistant heat generating layer, an electrode for supplying an electric current is provided on the electrically resistant heat generating layer in the contact manner. As the electrode, there is one formed according to a usual electroless plating method, specifically a method of preparing metal palladium from a supplied Pd—Sn complex, and allowing a plated film to deposit by the metal palladium as a catalyst (Patent Literature 5).

However the heat generating fixing belt in which the electrode is formed by such a usual electroless plating method does not have a sufficient adhesion between the electrode and the electrically resistant heat generating layer, and causes peeling-off of the electrode when using for a long period of time. Therefore since an electric resistance of the heat generating fixing belt during current supply increases, there is a problem that a desired conduction resistance cannot be maintained for a long period of time.

In addition, according to the usual electroless plating method, in order to immobilize metal palladium on the surface of the electrically resistant heat generating layer, it is necessary to subject the surface of the electrically resistant heat generating layer to roughening treatment, e.g. physical treatments such as plasma treatment, and chemical treatment by using a high risk oxidizing agent such as chromic acid, which raises a problem that steps to form the electrode are made complicate.

### CITATION LIST

### Patent Literature

[Patent Literature 1] Japanese Patent Application Laid-Open No. 2000-066539

[Patent Literature 2] Japanese Patent Application Laid-open No. 2004-281123

[Patent Literature 3] Japanese Patent Application Laid-Open No. 10-142972

[Patent Literature 4] Japanese Patent Application Laid-Open No. 2009-092785

[Patent Literature 5] Japanese Patent Application Laid-Open No. 2002-248705

### SUMMARY OF THE INVENTION

### Technical Problems

The present invention has been completed on the basis of the aforementioned background, and an object thereof is to provide a heat generating fixing belt which can maintain an initial conduction resistance for a long period of time, a method of forming an electrode relating to a heat generating fixing belt to obtain the heat generating fixing belt, and a fixing apparatus.

### Means to Solve the Problems

The method of forming an electrode relating to a heat generating fixing belt according to the present invention relates to a method in which the electrode is formed in the heat generating fixing belt including an electrically resistant heat generating layer composed of a resin in which an electrically conductive substance is dispersed, and a pair of electrodes which are formed on a surface of the electrically resistant heat generating layer to supply electric current to the electrically resistant heat generating layer, the method including

an electrode forming process where the electrode is prepared by supplying a colloid liquid where metal nano-particles are dispersed in a liquid medium onto the surface of an electrically resistant heat generating layer, and forming a plated film by an electroless plating method where the metal nano-particles are used as a catalyst.

In the method of forming an electrode relating to a heat generating fixing belt of the present invention, the metal nano-particles contains preferably silver, platinum or palladium, particularly preferably platinum or palladium.

In addition, in the method of forming an electrode relating to the heat generating fixing belt of the present invention, it is preferable that, in the electrode forming process, after depositing the plated film, a heat treatment is carried out by heating at 100 to 250° C.

In the method of forming an electrode relating to the heat generating fixing belt of the present invention, the resin which composes the electrically resistant heat generating layer is preferably a heat-resistant resin, more preferably a resin selected from polyphenylene sulfide (PPS), polyarylate (PAR), polysulfone (PSF), polyether sulfone (PES), polyether imide (PEI), polyimide (PI), polyamideimide (PAI), polyether ether ketone (PEEK) resins, particularly preferably a polyimide resin.

The heat generating fixing belt of the present invention relates to a heat generating fixing belt of the aforementioned method of forming an electrode relating to a heat generating fixing belt, in which the electrode includes a plated film containing metal nano-particles.

In the heat generating fixing belt of the present invention, the resin which composes the electrically resistant heat generating layer is preferably a heat-resistant resin, more preferably a resin selected from polyphenylene sulfide (PPS), polyarylate (PAR), polysulfone (PSF), polyether sulfone (PES), polyether imide (PEI), polyimide (PI), polyamideimide (PAI), polyether ether ketone (PEEK), particularly preferably a polyimide resin.

The fixing apparatus of the present invention is characteristically provided with the aforementioned heat generating fixing belt.

According to the method of forming an electrode relating to a heat generating fixing belt of the present invention, since a plated film is formed by means of an electroless plating method by using metal nano-particles as a catalyst, the adhesion between the electrode and the electrically resistant heat generating layer is sufficient. Therefore, even in the case of use for a long period of time, since the electrode is not peeled off, the heat generating fixing belt in which a desired conduction resistance can be maintained for a long period of time can be provided.

In addition, according to the method of forming an electrode relating to the heat generating fixing belt of the present invention, since roughening treatment and the like of the surface of the electrically resistant heat generating layer is not required, it is easy to form the plated film which composes the electrode. In addition, since a cyan compound such as typically potassium cyanide is not necessarily used, environmental loads can be controlled smaller.

### BRIEF DESCRIPTION OF THE DRAWINGS

FIG. 1 shows a schematic view to explain the method of forming an electrode relating to a heat generating fixing belt according to the present invention;

FIG. 2 shows a schematic partial sectional view of one example of the structure of the edge of the heat generating fixing belt according to the present invention;

FIG. 3 shows a schematic perspective view of one example of the structure of the fixing apparatus according to the present invention;

FIG. 4 shows a horizontal cross sectional view of the fixing apparatus shown in FIG. 3; and

FIG. 5 shows a vertical cross sectional view of the fixing apparatus shown in FIG. 3.

### DESCRIPTION OF THE EMBODIMENTS

In the following, the present invention is explained specifically.

The method of forming an electrode relating to the heat generating fixing belt of the present invention is a method of forming an electrode on a surface of an electrically resistant heat generating layer in a heat generating fixing belt mentioned in detail later characteristically includes an electrode forming process where the electrode is prepared by supplying a colloid liquid where metal nano-particles are dispersed in a liquid medium on the surface of the electrically resistant heat generating layer, and forming a plated film by an electroless plating method where the metal nano-particles are used as a catalyst.

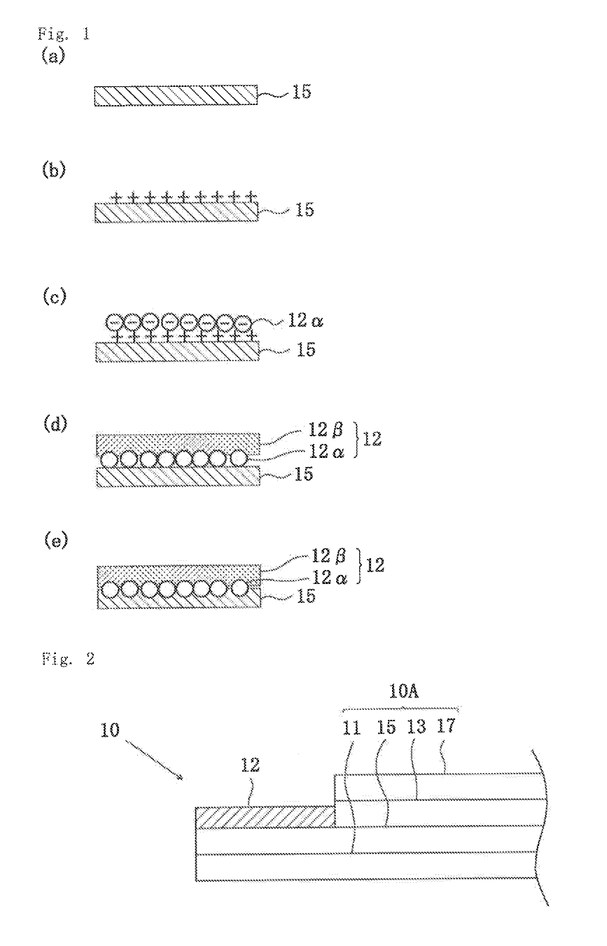

Specifically, as shown in FIG. 1, the electrode forming process is preferably composed of the following steps which are applied to an exposed portion where an electrode 12 of an electrically resistant heat generating layer 15 of a belt-shaped substrate 10A as explained in detail later (see FIG. 2) is formed.

(1) Washing step where the electrically resistant heat generating layer 15 is washed to be clean (see FIG. 1A),

(2) Positive charging step where the electrically resistant heat generating layer 15 is treated with a surfactant to be positively charged (see FIG. 1B),

(3) Catalytic metal thin film forming step where a catalytic metal thin film 12α is formed by applying a colloid liquid to the surface of the electrically resistant heat generating layer 15 and dried, and then negatively charged metal nano-particles are adsorbed and immobilized (see FIG. 1C), and

(4) Plated film forming step where a plated film 12β is deposited using the metal nano-particles of the catalytic metal thin film 12α as a catalyst (see FIG. 1D), and after the plated film forming step, the following step is preferably performed.

(5) Heat treatment step where heat treatment is conducted in order to immobilize strongly the metal nano-particles to the electrically resistant heat generating layer 15 (see FIG. 1E)

In the present invention, the electrode 12 may be composed of two films, i.e. the catalytic metal thin film 12α and the plated film 12β. If a desired thickness of the electrode 12 cannot be obtained, after the heat treatment step,

(6) Electro-plated film forming step where an electro-plated film is deposited on the plated film 12β using the plated film 12β as a catalyst by means of an electro-plating method may be conducted to obtain an electrode 12 which is composed of three films, i.e. the catalytic metal thin film 12α, the plated film 12β and the electro-plated film.

The washing step and the positive charging step may be carried out according to conventionally known methods.

In the catalytic metal than film forming step, the method for applying the colloid liquid on the surface of the electrically resistant heat generating layer 15 is not particularly limited and includes, for example, a dip coating method, a spray coating method, a spin coating method, a roll coating method, and the like, and particularly preferable is a dip coating method.

When the catalytic metal thin film 12α is formed according to the dip coating method, for example, a belt-shaped substrate 10A having the electrically resistant heat generating layer 15 is dipped into a colloid liquid so that a desired area on the belt-shaped substrate 10A where the electrode 12 is formed contacts with the colloid liquid. The dipping temperature may be, for example, room temperature, and the dipping period of time may be optionally selected depending on the kind and/or amount of the metal which composes the metal nano-particles, and may be, for example, from 30 minutes to 48 hours.

The metal nano-particles have a catalytic ability in the electroless plating method.

Examples of the metal nano-particles include nano-particles of noble metals such as gold, silver, ruthenium, rhodium, palladium, osmium, iridium and platinum; and copper, nickel, cobalt, and composite metals thereof and the like. Particularly preferable is one including platinum or palladium because of good dispersibility. These may be used alone or in combination of two or more.

The metal nano-particles have preferably an average particle diameter of 3-50 nm, more preferably 10-30 nm. When the metal nano-particles fall within the aforementioned range, it is possible to immobilize the metal nano-particles over the detailed area of the surface of the electrically resistant heat generating layer 15, which results in that a high adhesion of the plated film 12β to the electrically resistant heat generating layer 15 can surely be obtained. When the metal nano-particles are more than 50 nm, there is danger that the plated film 12β does not adhere sufficiently to the electrically resistant heat generating layer 15.

The liquid medium may be various known ones, specifically, water and organic medium, and the like. Examples of the organic medium includes a polar organic medium, e.g. an alcohol-based compound such as ethanol, a ketone-based compound such as acetone, an ether-based compound, an ester-based compound, and the like. These may be used alone or in combination of two or more.

The colloid liquid can be obtained, for example, by preparing metal nano-particles by reducing a metal ion in a metal compound in a liquid medium capable of dissolving the metal compound in the presence of a high molecular weight pigment dispersant.

The metal compound is a compound which yields a metal ion by being dissolved in a liquid medium, and is not particularly limited as far as a metal which generates desired metal nano-particles is contained. Examples thereof include tetrachloroauric (III) acid tetrahydrate (chloroauric acid), silver nitrate, silver acetate, silver (IV) perchloric acid, hexachloroplatinic (IV) acid hexahydrate (chloroplatinic acid), potassium chloroplatinate, platinum nitrate, cupper (II) chloride dihydrate, cupper (II) acetate monohydrate, cupper (II) sulfate, palladium (II) chloride dihydrate, rhodium (III) trichloride trihydrate, palladium (II) nitrate, and the like.

With respect to the concentration of the metal compound in the liquid medium, the metal molar concentration in the liquid medium is preferably 0.01 mole/L or more, more preferably 0.05 mole/L or more, still more preferably 0.1 mole/L or more. When the metal molar concentration in the liquid medium is less than 0.01 mole/L, there may be a case that the obtained colloid liquid cannot have a sufficient metal nano-particle concentration.

The high molecular weight pigment dispersant is an amphophilic copolymer, having a structure containing a liquid solvate moiety, where a functional group which has high affinity to the surface of the pigment is also introduced into a high molecular weight polymer, and is usually used as a pigment dispersant when preparing a pigment paste.

The high molecular weight pigment dispersant is co-existent with the metal nano-particles, and thought to have a role that stabilises the dispersion of the metal nano-particles in the liquid medium.

The number average molecular weight of the high molecular weight pigment dispersant is preferably 1,000-1,000,000, more preferably 2,000-500,000, further preferably 4,000-500,000. When the number average molecular weight of the high molecular weight pigment dispersant is less than 1,000, there is a case that sufficient dispersion stability may not be obtained, and when the number average molecular weight is more than 1,000,000, there is a case that handling may be difficult because the viscosity of the obtained colloid liquid becomes too high.

The high molecular weight pigment dispersant is not limited to a particular one as far as it has the aforementioned properties, and may include, for instance, examples mentioned in Japanese Patent Application Laid-Open No. 11-80647.

The used amount of the high molecular weight pigment dispersant is preferably 90% by mass or less based on the total amount of the metal in the metal compound and the high molecular weight pigment dispersant, more preferably 60% by mass or less, still more preferably 40% by mass or less, particularly preferably 20% by mass or less.

The reducing agent is not particularly limited as far as the aforementioned metal compound can be reduced to metal element. Specific examples include amines such as 2-dimethylaminoethtanol, sodium citrate, sodium ascorbate, sodium hydroborate, sodium hypophosphite, methanol, dimethyl amine borane, formaldehyde, and the like.

The added amount of the reducing agent is preferably an amount necessary to reduce the metal of the aforementioned metal compound or more. In the case of less than the amount, there may be a case that the reduction is insufficient. The upper limit is not particularly limited, and is, however, preferably 30 times or less of the amount necessary to reduce the metal of the aforementioned metal compound, more preferably 10 times or less.

The concentration (solid concentration) of the metal nano-particles of the colloid liquid is preferably within the range of from 1-50% by mass.

The metal nano-particles in the colloid liquid are negatively charged.

To the colloid liquid, any various solvents and additives may be added.

The thickness of the catalytic metal thin film 12α is different depending to the kind of metal which composes the catalytic metal thin film 12α and the size of the metal nano-particles from the metal, and, in the case where the metal which composes the catalytic metal thin film 12α is platinum, the thickness is preferably 30-300 nm, more preferably 100-200 nm.

In the plated film forming step, a method for depositing a plated film 12β on the catalytic metal thin film 12α can be carried out by supplying an electroless plating solution on the catalytic metal thin film 12α. The electroless plating solution can be supplied, for example, according to a method including a dip coating method, a spray coating method, a spin coating method, a roll coating method, and the like, and particularly preferable is a dip coating method.

When the catalytic metal thin film 12α is formed according to the dip coating method, for example, a belt-shaped substrate 10A having the electrically resistant heat generating layer 15 on which a catalytic metal thin film 12α is formed is dipped into an electroless plating solution so that the catalytic metal thin film 12α contacts with the electroless plating solution. The dipping temperature may be, for example, room temperature, and the dipping period of time may be optionally selected depending to the kind of the metal which composes the plated film 12β and the desired thickness of the plated film 12β, and may be, for example, from 10-30 minutes.

The metal to form the placed film 123 is not particularly limited as far as the metal has good electric conductivity, and includes gold, nickel, copper, platinum, palladium, silver, and the like, and is preferably nickel in view of less rusting.

The thickness of the plated film 12β may be, for example, 2-20 μm, and preferably 5-10 μm.

The heat treatment in the heat treatment step is different depending to the kind of the resin which composes the electrically resistant heat generating layer 15. The heating temperature is preferably 100-250° C., more preferably 150-200° C. The heating period of time is preferably 10 minutes-1 hour, particularly preferably 30 minutes.

When the heat treatment is carried out, the metal nano-particles are strongly immobilized to the electrically resistant heat generating layer 15, and thus, the adhesion of the plated film 12β to the electrically resistant heat generating layer 15 becomes strong, which results in enhancing the adhesion between the electrode 12 and the electrically resistant heat generating layer 15 extremely high.

The electro-plated film forming step may be carried out by using the plated film 12β as a catalyst by means of various conventional known electro-plating methods.

The metal to form the electro-plated film is not particularly limited as far as the metal has good electric conductivity, and includes, for example, gold, nickel, copper, platinum, palladium, silver, and the like, and is preferably nickel in view of less rusting.

The metal to form the electro-plated film may be the same as or different from, in type, the metal to form the plated film 12β.

The electrode 12 produced through the aforementioned electrode forming process is composed of the catalytic metal thin film 12α and the plated film 12β, and as necessary, the electro-plated film. The thickness of the electrode 12 is, for example, preferably 5-100 μm, and more preferably 30-60 μm.

[Heat Generating Fixing Belt]

The heat generating fixing belt of the present invention is, as shown in FIG. 2, configured by providing a belt-shaped substrate 10A on which at least an electrically resistant heat generating layer 15 composed of a resin in which an electrically conductive substance is dispersed, an elastic layer 13, a releasing layer 17 and a reinforcing layer 11 are laminated with one pair of the electrodes 12 which are formed so as to contact with the electrically resistant heat generating layer 15 to supply electric current so the electrically resistant heat generating layer 15. The electrode 12 is, as explained above, characterized by including a plated film containing the metal nano-particles formed according to a method including a specific electrode forming process.

Specifically, the elastic layer 13 is formed peripherally all over the center portion of the surface of the endless-shaped electrically resistant heat generating layer 15 in the axial direction, and the releasing layer 17 is formed on the surface of the elastic layer 13. In addition, the electrode 12 is formed on the region where the elastic layer 13 is not formed on the surface of the electrically resistant heat generating layer 15, namely, peripherally all over the region of the both edges in the axial direction. The reinforcing layer 11 is provided on the rear side of the electrically resistant heat generating layer 15.

The reinforcing layer 11 is optionally provided, as necessary, and the heat generating fixing belt 10 of the present invention may further be provided, with any other functional layers, as necessary.

[Electrically Resistant Heat Generating Layer]

(Resin)

The resin which composes the electrically resistant heat generating layer 15 relating to the heat generating fixing belt 10 of the present invention includes a so-called heat resistant resin. Herein, the heat resistant resin means a resin having a heat resistance in a short period of time is 200° C. or higher, and a heat resistance in a long period of time is 150° C. or higher.

Examples of the heat resistant resin include polyphenylene sulfide (PPS), polyarylate (PAR), polysulfone (PSF), polyether sulfone (PES), polyether imide (PEI), polyimide (PI), polyamideimide (PAI), polyether ether ketone (PEEK) resins, and the like, and the resin which composes the electrically resistant heat generating layer 15 relating to the heat generating fixing belt 10 of the present invention is particularly preferably a polyimide resin.

In the electrically resistant heat generating layer 15, it is extremely preferable that the heat resistant resin account for 40% by volume or more of the whole resins composing the layer.

(Electrically Conductive Substance)

Examples of the material of the electrically conductive substance dispersed in the electrically resistant heat generating layer 15 include a pure metal such as gold, silver, iron or aluminum; an alloy such as stainless steel or nichrome; and a non-metal such as carbon or graphite, and the shape of the electrically conductive substance is spherical powder, amorphous powder, flattened powder or fibrous, and the like.

The electrically conductive substance dispersed in the electrically resistant heat generating layer 15 relating to the heat generating fixing belt 10 of the present invention is fibrous graphite in view of heat generation.

Herein, the fibrous means the state that a major diameter (L) is larger than a minor diameter (l) by 4 times or more.

Such fibrous graphite can be prepared by conventional known preparation methods. Namely, when graphite which has been firstly drawn from a nozzle to be fibrous needs to be thinner, it is baked in a vessel at a temperature of 200-300° C., after stretching while being heated as necessary, for carbonization to prepare a fiber which is resistant to flame, followed by baking in a vessel at a high temperature of 1,000-3,000° C. As the result of these processes, impurities contained in the fiber other than carbon are fallen off, and a fiber having a remarkably strong carbon skeleton (molecular structure) can be prepared. According to these processes, first, a fiber of an electrically conductive substance having a desired minor diameter (l) is prepared, and then cut to a given length (major diameter (L)) to obtain the targeted fibrous graphite.

The volume resistivity of the electrically conductive substance is preferably 1×10⁻¹ Ω·m or less.

The volume resistivity of the fibrous electrically conductive substance is calculated according to the following expression (1) by measuring a difference of potential V (V) of electrodes distant from each other at a distance L when supplying a constant current I (A) to the electrically conductive substance in the case of being fibrous.

Volume resistivity ρv=(V·Wt)/IL Expression (1):

[wherein Wt represents the sectional area of the electrically conductive substance.]

The major diameter (L) of the fibrous electrically conductive substance is preferably 2-1,000 μm, and the minor diameter (l) is preferably 0.5-250 μm.

In the case where the minor diameter is less than 0.5 μm, when the electrically conductive substance particles dispersed in the electrically resistant heat generating layer 15 are brought into contact with each other, the contact resistance thereof is too large, whereby the electric resistance of the whole electrically resistant heat generating layer 15 may not be sufficiently lowered. In the case where the minor diameter is larger than 250 μm, since the dispersibility of the electrically conductive substance in the electrically resistant heat generating layer 15 becomes lowered, there may be a case that conduction resistance locally varies. In the case where the major diameter is less than 2 μm, it is difficult to form a charge conduction path, and in the case where the major diameter is more than 1,000 μm, the fiber cannot always exist in the manner of being extended long in the electrically resistant heat generating layer 15, and there may be a case that the conduction resistance in the electrically resistant heat generating layer locally varies.

In the above, the major diameter (L) and the minor diameter (l) of the fibrous electrically conductive substance are average values calculated by taking a picture of a magnification of 500 with a scanning type electron microscopy, preparing an image scanned with a scanner, and then measuring major diameters and minor diameters of optional 500 samples in the images.

The content of the electrically conductive substance in the electrically resistant heat generating layer 15 is 5-60% by mass.

The thickness of the electrically resistant heat generating layer 15 is preferably 10-300 μm, more preferably 30-200 μm.

The volume resistivity of the electrically resistant heat generating layer 15 is preferably 8×10⁻⁶ to 1×10⁻² Ω·m.

The volume resistivity of the electrically resistant heat generating layer 15 is calculated according to the following expression (2) by measuring a resistance between both edges of two electrodes which are provided by using an electrically conductive tape at the both edges of the heat generating fixing belt 10 along with the peripheral direction in the whole circumference.

Volume resistivity ρ=(R·d·W)/L Expression (2):

[wherein R represents a resistance value (Ω), d represents a thickness (m) of the electrically resistant heat generating layer 15, W represents a circumferential length (m) of the heat generating fixing belt 10, and L represents a length (m) of the distance between the electrodes.]

[Elastic Layer]

The elastic layer 13 which composes the heat generating fixing belt 10 is made of, for example, a heat resistant resin having elasticity, and the like.

Examples of the heat resistant resin having elasticity include silicone rubber, natural rubber (NR), butadiene rubber (BR), acrylonitrile butadiene rubber (NBR), hydrogenated NBR (H-NBR), styrene-butadiene rubber (SBR), isoprene rubber (IR), urethane rubber, chloroprene rubber (CR), chlorinated polyethylene (Cl-PE), epihalohydrin rubber (ECO, CO), butyl rubber (IIR), ethylene-propylene-diene polymer (EPDM), fluorine-containing rubber, acrylic rubber (ACM), and the like. Among them, CR, ECO, silicone rubber, butyl rubber, acryl rubber, urethane rubber are preferably used.

The thickness of the elastic layer 13 is preferably 50-300 μm, more preferably 100-200 μm.

[Releasing Layer]

The releasing layer 17 which composes the heat generating fixing belt 10 of the present invention is composed of, for example, polytetrafluoroethylene (PTFE), tetrafluoroethylene-perfluoro(alkylvinyl ether) copolymer (PFA), tetrafluoroethylene-hexafluoropropylene copolymer (FEP), and the like.

The thickness of the releasing layer 17 is preferably 1-20 μm, more preferably 2-10 μm.

[Reinforcing Layer]

The reinforcing layer 11 which composes the heat generating fixing belt 10 is optionally provided as necessary, and the reinforcing layer 11 is made of a heat resistant resin.

The heat resistant resin which composes the reinforcing layer 11 is the same as that exemplified as the resin which composes the electrically resistant heat generating layer 15.

The thickness of the reinforcing layer 11 is preferably 20-100 μm, more preferably 30-80 μm.

According to the heat generating fixing belt 10, since the electrode 12 contains a plated film which is formed by means of an electroless plating method by using metal nano-particles as a catalyst, adhesion between the electrode 12 and the electrically resistant heat generating layer 15 is sufficient. Therefore, in the case of use for a long period of time, since the electrode 12 is not peeled off, a desired conduction electric resistance can be maintained for a long period of time.

[Production Method of the Heat Generating Fixing Belt]

The aforementioned heat generating fixing belt 10 can be produced by forming the aforementioned electrode 12 on the belt-shaped substrate 10A having the electrically resistant heat generating layer 15.

The electrically resistant heat generating layer 15 can be formed by various known methods, and when the resin which composes the electrically resistant heat generating layer 15 is a polyamide resin, the belt-shaped substrate 10A is preferably formed as follows.

Specifically, the step include the following series of steps:
(1) A polyamide acid doping liquid preparing step where a polyamide acid doping liquid is prepared by adding an electrically conductive substance to polyamide acid.
(2) A belt-shaped precursor producing step where a belt-shaped precursor is obtained by applying the polyamide acid doping liquid on the reinforcing layer 11, followed by drying.
(3) An imidization reaction step where a polyimide resin is prepared by baking the belt-shaped precursor.

The reinforcing layer 11, the elastic layer 13, and the releasing layer 17 may be formed by proper methods, respectively.

(1) Polyamide Acid Doping Liquid Preparing Step

This polyamide acid doping liquid preparing step is a step where an aromatic tetracarboxylic acid and an aromatic diamine are condensation-polymerized to synthesize polyamide acid, and the electrically conductive substance is dispersed in the polyamide acid.

Specifically, the condensation polymerization is carried out in a solvent containing a good solvent of polyamide acid to obtain a polyamide acid solution where polyamide acid is dissolved therein.

The good solvent of polyamide acid is a solvent which can dissolve the polyamide acid homogeneously at 25° C. in a concentration of 20% by mass or more. Examples of the good solvent include organic polar solvents, e.g. amides such as N,N-dimethylacetamide, N,N-diethylacetamide, N,N-dimethylformamide, N,N-diethylformamide, N-methyl-2-pyrrolidone, and hexamethylsulphoneamide; sulfoxides such as dimethyl sulfoxide and diethylsulfoxide; and sulfones such as dimethylsulfone and diethylsulfone, and the like. These may be used alone or in combination of two or more.

As the good solvent, N-methylpyrrolidone is preferably used.

The used amount of the good solvent is such an amount that a concentration of polyamide acid in the polyamide acid solution obtained after condensation polymerization is, for example, within a range of 2-50% by mass.

As the method for condensation polymerization of aromatic tetracarboxylic acid and aromatic diamine, there may be employed various known methods. Specifically, for example, there is a method where aromatic tetracarboxylic acid and aromatic diamine are used in the almost the same mole and condensation-polymerization is carried out in a solvent within a temperature range of 100° C. or low, preferably 0-80° C. for 0.1-60 hours.

[Aromatic Teracarboxylic acid]

The aromatic tetracarboxylic acid used for synthesizing the polyamide acid is not particularly limited, and includes an aromatic tetracarboxylic acid, an anhydride thereof, a salt and ester thereof, and mixtures thereof, and particularly preferable is an aromatic tetracarboxylic acid dianhydride.

Examples of the aromatic tetracarboxylic acid dianhydride include pyromellitic acid dianhydride (PMDA), 1,2,5,6-naphthalenetetracarboxylic acid dianhydride, 1,4,5,8-naphthalenetetracarboxylic acid dianhydride, 2,3,6,7-naphthalenetetracarboxylic acid dianhydride, 2,2′,3,3′-biphenyltetracarboxylic acid dianhydride, 2,3,3′,4′-biphenyltetracarboxylic acid dianhydride, 3,3′,4,4′-biphenyltetracarboxylic acid dianhydride (BPDA), 2,2′,3,3′-benzophenonetetracarboxylic acid dianhydride, 2,3,3′,4′-benzophenonetetracarboxylic acid dianhydride, 3,3′,4,4′-benzophenonetetracarboxylic acid dianhydride (BTDA), bis(3,4-dicarboxyphenyl)sulfone dianhydride, bis(2,3-dicarboxyphenyl)methane dianhydride, bis(3,4-dicarboxyphenyl)methane dianhydride, 1,1-bis(2,3-dicarboxyphenyl)ethane dianhydride, 1,1-bis(3,4-dicarboxyphenyl)ethane dianhydride, 2,2-bis[3,4-(dicarboxyphenoxy)phenyl]propane dianhydride (BPADA), 4,4′-(hexafluoroisopropylidene)-di-phthalic acid, anhydride, oxydiphthalic acid anhydride (ODPA), bis(3,4-dicarboxyphenyl)sulfoxide dianhydride, thiodiphthalic acid dianhydride, 3,4,9,10-perrlenetetracarboxylic acid anhydride, 2,3,6,7-anthracene tetracarboxylic acid dianhydride, 1,2,7,8-phenathrenetetracarboxylic acid dianhydride, 9,9-bis(3,4-dicarboxyphenyl)fluorene dianhydride, and 9,9-bis[4-(3,4′-dicarboxyphenoxy)phenyl]fluorene. Among them, particularly preferable are pyromellitic acid dianhydride (PMDA), 3,3′,4,4′-biphenyltetracarboxylic acid dianhydride (BPDA), 3,3′,4,4′-benzophenonetetracarboxylic acid dranhydride (BTDA), 2,2-bis[3,4-(dicarboxyphenoxy)phenyl]propane anhydride (BPADA), and oxydiphthalic acid anhydride (ODPA).

These compounds may be used alone or in combination of two or more.

The used amount of aromatic tetracarboxylic acid may be such an amount that a molar ratio of aromatic tetracarboxylic acid:aromatic diamine is 0.85:1-1.2:1.

The number average molecular weight of the polyamide acid is preferably 1,000 or more, more preferably 2,000-500,000, particularly preferably 5,000-150,000.

The number average molecular weight of the polyamide acid is a value obtained by measuring a tetrahydrofuran (THF)-dissolved portion with gel permeation chromatography (GPC). Specifically, the measurement is carried out as follows: an apparatus “HLC-8220” (available from TOSOH CORPORATION) and column “TSK guardcolumn+TSK gel Super HZM-M3 triple series” (available from TOSOH CORPORATION) are used; tetrahydrofuran (THF) is allowed to flow as a carrier medium at a flow rate of 0.2 ml/min while maintaining the column temperature at 40° C.; a sample to be measured is dissolved in tetrahydrofuran in a concentration of 1 mg/ml under dissolving conditions where ultrasonic treatment is carried out for 5 minutes with an ultrasonic disperser at room temperature; subsequently, a sample solution is prepared by treatment with a membrane filter having a pore size of 0.2 μm; 10 μl of this sample solution is injected into the apparatus together with the aforementioned carrier medium; detection is carried out by using a refractive index detector (RI detector); and then calculation of a molecular weight dispersion of the sample is carried out by using a calibration curve prepared by using monodispersed polystyrene standard particles. The standard polystyrene samples used for the calibration curve are samples available from Pressure Chemical Co. having a molecular weight of 6×10², 2.1×10³, 4×10³, 1.75×10⁴, 5.1×10⁴, 1.1×10⁵, 3.9'10⁵, 8.6×10⁵, 2×10⁶, 4.48×10⁶. The calibration curve is prepared by measuring at least about 10 standard polystyrene samples. Further, the detector used is a refractive index detector.

[Aromatic Diamine]

Examples of the aromatic diamine used to synthesize polyamide acid include p-phenylenediamine (PPD), m-phenylenediamine (MPDA), 2,5-diaminotoluene, 2,6-diaminotoluene, 4,4′-diaminobiphenyl, 3,3′-dimethyl-4,4′-biphenyl, 3,3′-dimethoxy-4,4′-biphenyl, 2,2′-bis(trifluoromethyl)-4,4′-diaminobiphenyl, 3,3′-diaminodiphenylmethane, 4,4′-diaminodiphenylmethane (MDA), 2,2-bis-(4-aminophenyl)propane, 3,3′-diaminodiphenylsulfone (33DDS), 4,4′-diaminoidiphenylsulfone (44DDS), 3,3′-diaminodiphenylsulfide, 4,4′-diaminodiphenylsulfide, 3,3′-diaminodiphenyl ether, 3,4′-diaminodiphenyl ether (34ODA), 4,4′-diaminodiphenyl ether (ODA), 1,5-diaminonaphthalene, 4,4′-diaminodiphenyldiethyl silane, 4,4′-diaminodiphenyl silane, 4,4′-diaminodiphenylethylphosphine oxide, 1,3-bis(3-aminophenoxy)benzene (133APB), 1,3-bis(4-aminophenoxy)benzene (134APB), 1,4-bis(4-aminophenoxy)benzene, bis[4-(3-aminophenoxy)phenyl]sulfone (BAPSM), bis[4-(4-aminophenoxy)phenyl]sulfone (BAPS), 2,2-bis[4-(4-aminophenoxy)phenyl]propane (BAPP), 2,2-bis(3-aminophenyl)-1,1,1,3,3,3-hexafluoropropane, 2,2-bis(4-aminophenyl)-1,1,1,3,3,3-hexafluoropropane and 9,9-bis(4-aminophenyl)fluorene, and the like. Among them, particularly preferable are p-phenylenediamine (PPD), m-phenylenediamine (MPDA), 4,4′-diaminodiphenylmethane (MDA), 3,3′-diaminodiphenylsulfone (33DDS), 4,4′-diaminodiphenylsulfone (44DDS), 3,4′-diaminodiphenyl ether (34ODA), 4,4′-diaminodiphenyl ether (ODA), 1,3-bis(3-aminophenoxy)benzene (133APB), 1,3-bis(4-aminophenoxy)benzene (134APB), bis[4-(3-aminophenoxy)phenyl]sulfone (BAPSM), bis[4-(4-aminophenoxy)phenyl]sulfone (BAPS), and 2,2-bis[4-(4-aminophenoxy)phenyl]propane (BAPP), and the like.

These compounds may be used alone or in combination of two or more.

The polyamide acid doping liquid is prepared by dissolving or dispersing the electrically conductive substance in the polyamide acid solution obtained by the aforementioned method, and if necessary, adding an electrically conductive agent, a surfactant, a viscosity controlling agent, and the like, and if necessary, regulating the concentration and viscosity by adding a solvent for dilution.

The total amount of the solvent in the polyamide acid doping liquid is preferably 20-90% by mass, more preferably 40-70% by mass.

The viscosity of the polyamide acid doping liquid is not particularly limited as far as the electrically resistant heat generating layer 15 having a desired thickness can be obtained, and for example, the viscosity is 10 cp-10,000 cp.

As additives such as the surfactant and the viscosity controlling agent, there may be used substances described in “SAISHIN POLYIMIDE—KISO TO OUYO—(Latest Polyimides—Basics and Applications)” edited by NIPPON POLYIMIDE KYOKAI (published from NTS) and “SAISINNO POLYIMIDE ZAIRYO TO OUYOGIJUTU” (Latest Polyimide Materials and Applied Techniques)” (general editorship of Masaaki KAKIMOTO, published from CMC).

When adding the electrically conductive substance and/or additives which are not dissolved in the polyamide acid doping liquid, it is preferable to employ means to accomplish homogeneous dispersion with respect to the polyamide acid doping liquid. For example, preferable is mixing/dispersion by using known mixers such as mixing with mixing blades, mixing with a static mixer, mixing with an uniaxial kneader or biaxial kneader, mixing with a homogenizer, and mixing with an ultrasonic dispenser.

(2) Belt-Shaped Precursor Producing Step

The belt-shaped precursor producing step is a step for producing a belt-shaped precursor by applying the polyamide acid doping liquid on the reinforcing layer 11 by, for example, a casting method, and then removing the solvent by evaporation.

As the method for applying the polyamide acid doping liquid on the reinforcing layer 11, there are employed means for forming thin film such as a bar coater, a doctor blade, a slide hopper, spray coating, spiral coating, T die extrusion, and the like.

The drying temperature for evaporating the solvent is not particularly limited as far as the solvent can be evaporated and its temperature is lower than the initiation temperature of imidization reaction mentioned later, and the drying temperature is, for example, 40-280° C., preferably 80-260° C., more preferably 120-240° C., particularly preferably 120-220° C.

This drying may continue until the solvent content of the dried belt-shaped precursor becomes an extent that is suitable to produce the belt-shaped precursor.

(3) Imidization Reaction Step

This imidization reaction step is a step for forming the electrically resistant heat generating layer 15 of a polyimide resin by baking the belt-shaped precursor at a particular baking temperature for a predetermined period of time to convert polyamide acid to polyimide.

The particular baking temperature in the imidization reaction is an initiation temperature of imidization, and usually 280° C. or higher, preferably 280-400° C., more preferably 300-380° C., particularly preferably 330-380° C.

The baking time is usually 10 minutes or more, preferably 30-240 minutes.

[Fixing Apparatus]

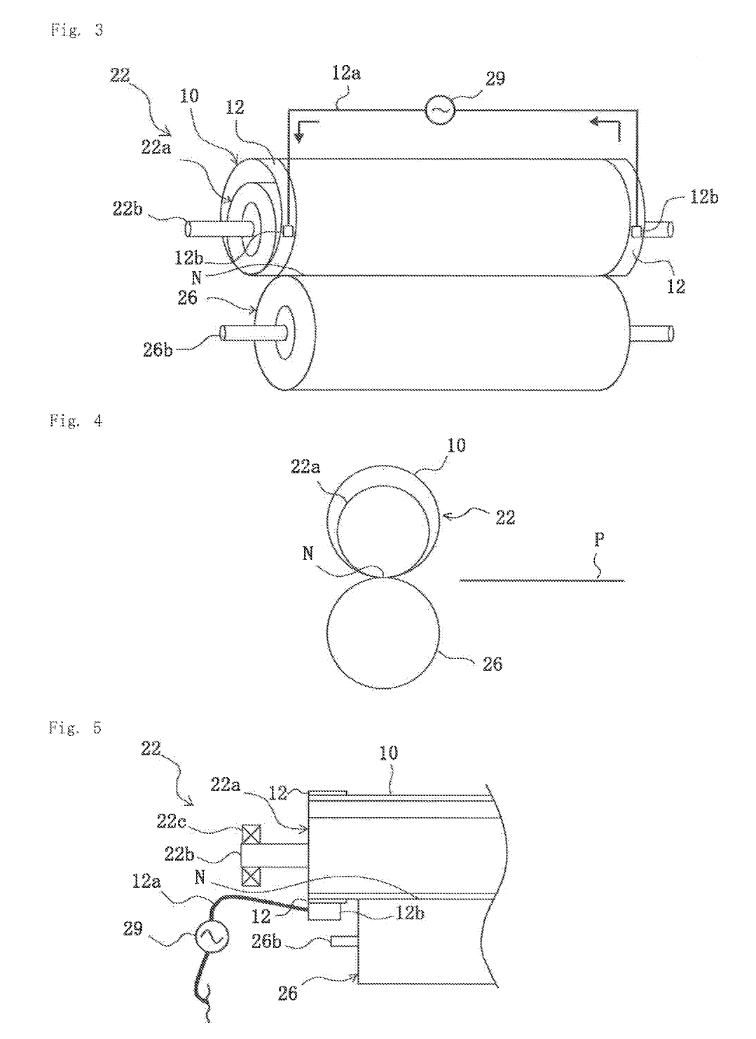

The fixing apparatus of the present invention includes, as shown in FIGS. 3 to 5, for example, one fixing rotating body 22 which contacts with one surface of an image support P where a toner image is formed and a pressure roller 26 which is the other fixing rotating body, and these bodies are in contact with each other under pressure. The pressure contact portion of the fixing rotating body 22 and the pressure roller 26 forms a nip portion N.

The one fixing rotating body 22 which contacts with one surface of the image support P where a toner image is formed has an endless heat generating fixing belt 10 of the present invention. On the inner side of the heat generating fixing belt 10, a nip portion forming roller 22a is provided so as to be in pressure contact with the pressure roller 26 via the heat generating fixing belt 10.

In FIG. 3, 12a represents a lead wire, 22b represents the shaft of the nip portion forming roll 22a, and 26b represents the shaft of the pressure roller 26. In FIG. 5, 22c represents a driving gear to rotate the nip portion forming roll 22a.

In the fixing apparatus 20 of this example, the length of the pressure roller 26 in the axial direction is shorter than the nip portion forming roll 22a, and also the length of the heat generating fixing belt 10 in the axial direction is almost the same as the length of the nip portion forming roll 22a in the axial direction. In addition, only the center portion of the heat generating fixing belt 10 is in pressure contact with the pressure roller 26, and one pair of electrodes 12, 12 are provided on the both edges of the heat generating fixing belt 10 where the pressure roller 26 is not in contact. These electrodes 12 are connected to a high frequent power source 29 via a current supplying member 12b.

As the current supplying member 12b, employable are, for example, carbon brushes formed of copper graphite, carbon graphite, or the like.

Supply of current to the heat generating fixing belt 10 is carried out, for example, from the high frequent power source 29 through bundled wires or a harness via the current supplying member 12b and the electrode 12.

Supply of current from the current supplying member 12b to the electrode 12 is carried out, for example, by allowing the current supplying member 12b to contact with only the electrode 12. As specific contact methods, there are listed a sliding contact method and a rotation contact method by using rollers, and the like.

The contact load between the current supplying member 12b and the electrode 12 is such a load that conduction can be ensured and an excessive stress is not applied to the driving of the heat generating fixing belt 10.

In the fixing apparatus 20, an image support P on which a toner image are formed all over the surface is conveyed in such a manner that the support is nipped by the nip portion N, and then the toner image is fixed on the image support P.

[Image Forming Apparatus]

The fixing apparatus of the present invention can be mounted in image forming apparatuses having various known configurations.

[Image Support]

In the image forming method by using the fixing apparatus of the present invention, examples of the image support P where a toner image is fixed include plain paper ranging from thin paper to thick paper, quality paper, coated print paper such as art paper or coated paper, commercially available Japanese paper or postcard paper, plastic film for OHP, fabrics, and various ones, and the support is not limited thereto.

In the above, the embodiments according to the present invention have been explained specifically, and the embodiments according to the present invention are not limited to the above examples, and may be modified variously.

For example, between the electrically resistant heat generating layer 15 and the elastic layer 13 of the heat generating fixing belt 10, a primer layer may be provided for stabilizing the adhesion. The thickness of the primer layer is, for example, 2-5 μm.

### EXAMPLES

Hereinafter, specific examples of the present invention will be explained, and the present invention is not limited thereto.

### Production Example 1 of the Belt-Shaped Substrate

(1) Preparation of a Polyamide Acid Doping Liquid

A polyamide acid, doping liquid [1] was prepared by sufficiently mixing 100 g of polyamide acid. “U-varnish S301” (produced by Ube Kosan Co., Ltd.) and 18 g of graphite fibers “XN-100” (produce by Nippon Graphite Fiber Co.) as the electrically conductive substance in a planetary mixer.

(2) Formation of a Reinforcing Layer and an Electrically Resistant Heat Generating Layer

A precursor of the reinforcing layer was produced by applying the polyamide acid “U-varnish S301” (produced by Ube Kosan Co., Ltd.) at a thickness of 500 μm to a stainless steel pipe having an outer diameter of 30 mm and a whole length of 345 mm, and then by drying the coated article at 120° C. for 20 minutes. A belt-shaped precursor was produced by applying the aforementioned polyamide acid doping liquid [1] on the reinforcing layer at a thickness of 500 μm, and then drying at 150° C. for 3 hours. By drying the precursor under nitrogen atmosphere at 320° C. for 120 minutes to be imidized, the reinforcing layer and the electrically resistant heat generating layer were formed, and then a laminated structure [A1] formed of an endless polyimide resin belt was produced.

(3) Formation of an Elastic Layer

A laminated structure [A2] having an elastic layer provided on the laminated structure [A1] was formed by applying a primer “331565” (produced by Shin-Etsu Cmemical Co., Ltd.) with a brush on the center portion except a 20 mm width range from both edges of the laminated structure [A1] and drying at a normal temperature for 30 minutes to form a primer layer, applying, on the primer layer, a mixed composition of a liquid rubber of silicone rubber “E1379” (produced by Shin-Etsu Chemical Co., Ltd.) and silicone rubber “DY356013” (produced by Dow Corning Toray Co., Ltd.) which were previously mixed at a ratio of 2:1 at a thickness of 200 μm, and thereafter, heating at 150° C. for 30 minutes for primary vulcanization, followed by further heating at 200° C. for 4 hours for post-vulcanization to form an elastic layer on the primer layer. The hardness of the elastic layer was 26 degrees.

(4) Formation of a Releasing Layer

After cleaning the surface of the elastic layer of the laminated structure [A2], the laminated structure [A2] was dipped in a PTFE resin dispersion “30J” (produced by du Pont de Nemours & Co.) as a fluororesin (B) while being rotated for 3 minutes and taken out, followed by drying at normal temperature for 20 minutes. Subsequently, after wiping the fluororesin on the surface of the elastic layer with a cloth, a fluororesin dispersion “855-510” (produced by du Pont de Nemours & Co.) in which a PTFE resin and a PFA resin, as a fluororesin (A), were mixed at a ratio of 7:3 and adjusted to a solid content of 45% and a viscosity of 110 mPa·s was applied on the layer of the fluororesin (B) at a finished thickness of 15 μm, dried at room temperature for 30 minutes, and then heated at 230° C. for 30 minutes. After that, by being passed through a tubular furnace having an inside diameter of 100 mm at a set inner furnace temperature of 270° C. over about 10 minutes, the fluororesin was formed by sintering, and cooled to form a releasing layer on the elastic layer of the laminated structure [A2], whereby the belt-shaped substrate [1] was produced.

### Example 1

### Forming Example 1 of Electrode

(1) Preparation of Colloid Liquid

20 g of a dispersing agent “DISPERBYK-191” (produced by BYK Chemie BmgH) was added into 500 g of pure water, and stirred.

In a separated vessel, 100 g of silver nitrate was added into 500 g of pure water and stirred at an elevated temperature of 50° C. to dissolve the silver nitrate.

The two solutions were mixed, and thereto, 262.0 g of 2-dimethylaminoethanol was added instantaneously while stirring at an elevated temperature of 50° C. At the time when the reaction temperature was decreased to 50° C., the stirring was continued for 2 hours while maintaining the temperature of 50° C. After adding 300 g of ethanol, the stirring was continued at 50° C. for 3 hours to prepare a silver colloid liquid [1] where silver nano-particles were dispersed.

(2) Preparation of a Catalytic Metal Thin Film Forming Coating Liquid

A catalytic metal thin film forming coating liquid [1] was prepared by mixing 100 g of the silver colloid liquid [1], 10 g of an epoxy-based silane coupling agent “KBM-402” (produced by Shin-Etsu Chemical Co., Ltd. ) and 500 g of isopropyl alcohol.

(3) Formation of a Catalytic Metal Thin Film

Each of the 20 mm width ranges from both edges of the aforementioned belt-shaped substrate [1] was dipped in “ATS CONDICLIN CIW-2” (produced by Okuda Chemical Industries Ltd.) to surface-treat the edge portions, and then water-washing and drying were carried out in this order.

Next, a catalytic metal thin film was prepared by dip-coating each of the 20 mm width ranges from both edges of the aforementioned belt-shaped substrate [1] with the aforementioned catalytic metal thin film forming coating liquid [1], followed by drying at 70° C. for 30 minutes to evaporate the liquid medium.

(4) Formation of a Plated Film

A heat generating fixing belt [1] was produced by dipping each of the 20 mm width ranges from both edges of the aforementioned belt-shaped substrate [1] in an electroless nickel plating liquid “IPC NICOLON EPF” (produced by Okuda Chemical Industries Ltd.), and dried at room temperature to form a nickel plated film on the catalytic metal thin film as electrodes for production of a heat generating fixing belt [1]. After that, the heat generating fixing belt [1] was separated from the stainless steel pipe. The thickness of the electrode was 5 μm.

### Example 2

### Forming Example 2 of Electrode

A heat generating fixing belt [2] was produced in the same manner as in the Forming Example 1 of electrode except that, after forming the nickel plated film by dipping in the electroless nickel plating liquid and drying, a heat treatment at 150° C. for 30 minutes was carried out. The thickness of the electrode was 5 μm.

### Example 3

### Forming Example 3 of Electrode

A heat generating fixing belt [3] was produced in the same manner as in the Forming Example 2 of electrode except that platinum nitrate was used instead of silver nitrate. The thickness of the electrode was 5 μm.

### Example 4

### Forming Example 4 of Electrode

A heat generating fixing belt [4] was produced in the same manner as in the Forming Example 2 of electrode except that palladium nitrate was used instead of silver nitrate. The thickness of the electrode was 5 μm.

### Comparative Example 1

### Forming Example 5 of Electrode

Each of the 20 mm width ranges from both edges of the aforementioned belt-shaped substrate [1] was treated by degreasing with an organic solvent and drying, chemically roughening the surface with chromic acid as etching, and removing the remaining chromic compound with hydrochloric acid, and then water-washing and drying were carried out in this order.

Next, to each of the 20 mm width ranges from both edges of the aforementioned belt-shaped substrate [1], a catalytic metal Pd—Sn compound which became a core of the electroless plating was adsorbed as a catalyst.

Subsequently, after dissolving the tin salt to yield metal palladium by oxidation-reduction reaction, the substrate was dipped into the electroless nickel plating liquid “IPC NICOLON FPF” (produced by Okuda Chemical Industries Ltd.), and dried at room temperature to form a nickel plated film. A comparative heat generating fixing belt [5] was produced by further laminating a nickel plated film to form electrodes by nickel electroplating. After that, the heat generating fixing belt [5] was separated from the stainless steel pipe. The thickness of the electrode was 5 μm.

<Performance Evaluation>

By using a modified machine of a medium speed machine “bizhub C353” (produced by Konica Minolta Business Technologies, Inc.) using the heat generating fixing belts [1]-[5] as the heat generating fixing belt, a printing durability test was conducted by forming 10,000 sheets of prints on which a gray solid image was fixed. The adhesion property of each plated film before and after the printing durability test was evaluated by carrying out a tape-peeling test according to “Method for testing adhesion in plating” defined in JIS H8504 based on the following evaluation criteria. The results are shown in Table 1.

### Evaluation Criteria

A: No peeling-off or bulging of the plated film is visually observed at all (Practically usable).

B: Float of the plated film is visually observed (Practically usable).

C: Peeling-off of the plated film is visually observed (Practically unusable).

TABLE 1

| | | | Heat | | |
|---|---|---|---|---|---|
| | | | treatment | Adhesion property | |
| | Heat | | after | Before | After |
| | generating | Metal | formation | printing | printing |
| | fixing belt | nano- | of | durability | durability |
| | No. | particles | plated film | test | test |
| Example 1 | [1] | silver | none | A | B |
| Example 2 | [2] | silver | Done | A | A |
| Example 3 | [3] | platinum | Done | A | A |
| Example 4 | [4] | palladium | Done | A | A |
| Comparative | [5] | — | none | A | C |
| Example 1 | | | | | |

### DESCRIPTION OF THE SYMBOLS

10 Heat generating fixing belt

10A Belt-shaped substrate

11 Reinforcing layer

12 Electrode

12α Catalytic metal thin film

12β Plated film

12a Lead wire

12b Current supplying member

13 Elastic layer

15 Electrically resistant heat generating layer

17 Releasing layer

20 Fixing apparatus

22 Fixing rotating body

22a Nip portion forming roll

22b Shaft

22c Driving gear

26 Pressure roller

26b Shaft

29 High frequency power source

N Nip portion

P Image support

What is claimed is:

1. An electrode forming method relating to a heat generating fixing belt in which an electrode is formed in a heat generating fixing belt including an electrically resistant heat generating layer composed of a resin in which an electrically conductive substance is dispersed and a pair of electrodes which are formed on the surface of the electrically resistant heat generating layer to supply electric current to the electrically resistant heat generating layer, wherein the method comprising an electrode forming process where an electrode is obtained by supplying a colloid liquid in which metal nano-particles are dispersed in a liquid medium on the surface of an electrically resistant heat generating layer, and forming a plated film by an electroless plating method using the metal nano-particles as a catalyst.

2. The electrode forming method relating to a heat generating fixing belt according to claim 1, wherein the metal nano-particles are composed of silver, platinum or palladium.

3. The electrode forming method relating to a heat generating fixing belt according to claim 1, wherein the metal nano-particles are composed of platinum or palladium.

4. The electrode forming method relating to a heat generating fixing belt according to claim 1, wherein a heat treatment is carried out by heating at 100-250° C. after depositing a plated film, in the electrode forming process.

5. The electrode forming method relating to a heat generating fixing belt according to claim 1, wherein a resin which composes the electrically resistant heat generating layer is a heat-resistant resin.

6. The electrode forming method relating to a heat generating fixing belt according to claim 1, wherein the resin which composes the electrically resistant heat generating layer is a resin selected from polyphenylene sulfide (PPS), polyarylate (PAR), polysulfone (PSF), polyether sulfone (PES), polyether imide (PEI), polyimide (PI), polyamideimide (PAI), polyether ether ketone (PEEK).

7. The electrode forming method relating to a heat generating fixing belt according to claim 1, wherein the resin which composes the electrically resistant heat generating layer is a polyimide resin.

8. A heat generating fixing belt including an electrically resistant heat generating layer composed of a resin in which an electrically conductive substance is dispersed and a pair of electrodes formed on the surface of the electrically resistant heat generating layer to supply electric current to the electrically resistant heat generating layer wherein the electrode is formed according to the electrode forming method relating to a heat generating fixing belt according to claim 1, wherein
the electrode comprises a plated film containing metal nano-particles.

9. The heat generating fixing belt according to claim 8, wherein the resin which composes the electrically resistant heat generating layer is a heat-resistant resin.

10. The heat generating fixing belt according to claim 8, wherein the resin which composes the electrically resistant heat generating layer is a resin selected from polyphenylene sulfide (PPS), polyarylate (PAR), polysulfone (PSF), polyether sulfone (PES), polyether imide (PEI), polyimide (PI), polyamideimide (PAI), polyether ether ketone (PEEK).

11. The heat generating fixing belt according to claim 8, wherein the resin which composes the electrically resistant heat generating layer is a polyimide resin.

12. A fixing apparatus comprising the heat generating fixing belt according to claim 8.
